(19) United States
(12) Patent Application Publication
(10) Pub. No.: US 2023/0339103 A1
(43) Pub. Date: Oct. 26, 2023

(54) INFORMATION PROCESSING SYSTEM, INFORMATION PROCESSING METHOD, ROBOT SYSTEM, ROBOT SYSTEM CONTROL METHOD, ARTICLE MANUFACTURING METHOD USING ROBOT SYSTEM, AND RECORDING MEDIUM

(71) Applicant: CANON KABUSHIKI KAISHA, Tokyo (JP)

(72) Inventors: SATOSHI SUGAYA, Kanagawa (JP); SATOSHI NUKUSHINA, Kanagawa (JP)

(21) Appl. No.: 18/301,354

(22) Filed: Apr. 17, 2023

(30) Foreign Application Priority Data
Apr. 26, 2022 (JP) 2022-072226
Mar. 14, 2023 (JP) 2023-039698

(51) Int. Cl. B25J 9/16

(52) U.S. Cl. CPC B25J 9/1605; B25J 9/1697

(57) ABSTRACT

An information processing system includes a device that includes a movable unit including a measurement unit configured to measure a shape of an object, and a simulation unit that performs an operation simulation for the device in a virtual space by using a virtual model. The movable unit moves the measurement unit to a predetermined measurement point. The measurement unit measures a target existing in a surrounding environment of the device at the predetermined measurement point. A model including position information of the target is acquired by using a measurement result and information regarding the predetermined measurement point. The simulation unit sets a virtual model of the target in the virtual space by using the model.

### BACKGROUND OF THE INVENTION

### Field of the Invention

The present invention relates to an information processing system and a robot system.

### Description of the Related Art

As a method of developing a control program for causing a device such as a robot to perform a predetermined operation, there is known a method of teaching a device to perform an operation while actually operating the device and checking whether or not the device interferes with an object in a surrounding environment. However, in a case of developing the program by operating the actual device, there is a risk that interference actually occurs and the device is damaged, and it takes time to check the operation, and the control program may not be efficiently developed.

Therefore, a method has been attempted in which a device model is operated in a virtual space by using three-dimensional model information of the device and an object in a surrounding environment of the device, and a control program for a device is developed while checking whether or not the device model interferes with an object model. In order to appropriately perform a simulation in the virtual space, it is necessary to construct an accurate three-dimensional model of the device and the surrounding environment in a simulation device in advance.

Examples of the object in the surrounding environment of the device include structures such as walls and columns, and other devices installed around the device, but three-dimensional shape information (for example, CAD data) of the objects does not necessarily exist.

Japanese Patent Application Publication No. 2003-345840 discloses a method of measuring a target placed on a reference surface to acquire point cloud data, creating surface data from the point cloud data, and creating solid data by using the surface data to create a three-dimensional model on a CAD system.

### SUMMARY OF THE INVENTION

According to a first aspect of the present invention, an information processing system includes a device that includes a movable unit including a measurement unit configured to measure a shape of an object, and a simulation unit that performs an operation simulation for the device in a virtual space by using a virtual model. The movable unit moves the measurement unit to a predetermined measurement point. The measurement unit measures a target existing in a surrounding environment of the device at the predetermined measurement point. A model including position information of the target is acquired by using a measurement result and information regarding the predetermined measurement point. The simulation unit sets a virtual model of the target in the virtual space by using the model.

According to a second aspect of the present invention, a robot system includes a robot that includes a movable unit including a measurement unit configured to measure a shape of an object, and a simulation unit that performs an operation simulation for the robot in a virtual space by using a virtual model. The movable unit moves the measurement unit to a predetermined measurement point. The measurement unit measures a target existing in a surrounding environment of the robot at the predetermined measurement point. A model including position information of the target is acquired by using a measurement result and information regarding the predetermined measurement point. The simulation unit sets a virtual model of the target in the virtual space by using the model.

Further features of the present invention will become apparent from the following description of exemplary embodiments with reference to the attached drawings.

### BRIEF DESCRIPTION OF THE DRAWINGS

FIG. 1 is a schematic diagram illustrating a schematic configuration of an information processing system 100 according to a first embodiment.

FIG. 2 is a functional block diagram for describing the information processing system 100 according to the first embodiment.

FIG. 3 is a diagram illustrating a configuration of each of a robot control device A, a vision sensor control device B, a model creation device C, and a simulation device D.

FIG. 4 is a flowchart for describing a procedure of imaging preparation.

FIG. 5A is a view for describing a measurement range IMA (measurement range) that can be accurately measured (imaged) by a vision sensor 102.

FIG. 5B is a conceptual view for describing setting of a measurement point.

FIG. 6A is a schematic view for describing a second teaching method for teaching a measurement point.

FIG. 6B is a view for describing automatic setting of the measurement point.

FIG. 7 is a diagram for describing a suitable setting method for the measurement point.

FIG. 8 is a flowchart for describing an imaging (measurement) procedure.

FIG. 9 is a schematic diagram for describing synthesis processing and filter processing for point cloud data acquired at each measurement point.

FIG. 10 is a flowchart for describing a three-dimensional model generation procedure.

FIG. 11 is a schematic diagram for describing transition of a data form in each step of model generation.

FIG. 12 is a view illustrating an example in which a virtual model 101M and a virtual model 103M generated with a correct positional relationship in a virtual space are displayed on a display device E.

FIG. 13 is an example view of a measurement setting screen 400 according to a second embodiment.

FIG. 14 is a flowchart according to the second embodiment.

FIG. 15 is an example view illustrating a virtual space according to the second embodiment.

FIG. 16A is a schematic view for describing a division width calculated from sensor information for acquisition of a measurement point according to the second embodiment.

FIG. 16B is a schematic view for describing division of a measurement area.

FIG. 17A is a schematic view for the measurement points and a posture of a robot according to the second embodiment, illustrating a state of measurement points corresponding to an angle of 0 degrees.

FIG. 17B is a schematic view illustrating a state of measurement points corresponding to a tilted angle of Drx in an X-axis direction.

FIG. 18A is a schematic view for the measurement point and the posture of the robot according to the second embodiment, illustrating a state in which a movement-prohibited area and the robot interfere with each other.

FIG. 18B is a schematic view illustrating a state of the robot whose angle is different at the same position for the measurement point.

FIG. 19 is a flowchart according to a third embodiment.

FIG. 20 is a schematic view for describing layering of measurement points according to the third embodiment.

FIG. 21A is a schematic view illustrating measurement points of an N-th layer and a measurement state for describing a procedure for excluding measurement points according to the third embodiment.

FIG. 21B is a schematic view at the time of point cloud data acquisition processing.

FIG. 21C is a schematic view of a meshed model.

FIG. 21D is a schematic view illustrating a state in which a linear model of a focal length of a sensor for a measurement point in an N+1-th layer and the meshed model intersect each other.

FIG. 21E is a schematic view illustrating excluded measurement points.

FIG. 22 is an example view of a measurement setting screen 400 according to a fourth embodiment.

FIG. 23 is a schematic diagram illustrating a schematic configuration of an information processing system according to a fifth embodiment.

FIG. 24 is a schematic diagram illustrating a schematic configuration of an information processing system according to a sixth embodiment.

FIG. 25 is a functional block diagram for describing a configuration of the information processing systems according to the fifth embodiment and the sixth embodiment.

FIG. 26 is a schematic view illustrating a robot 101 according to a seventh embodiment.

### DESCRIPTION OF THE EMBODIMENTS

In a case where three-dimensional shape information (for example, 3D CAD data) of an object in a surrounding environment of a device does not exist, if the object can be placed on a reference surface, a three-dimensional model can be created on a CAD system by the method of Japanese Patent Application Publication No. 2003-345840. However, for a structure that cannot be placed on the reference surface of the measurement device, such as a wall or a column, three-dimensional shape information cannot be acquired by the method of Japanese Patent Application Publication No. 2003-345840.

In addition, even if three-dimensional shape information (for example, 3D CAD data) of an object in the surrounding environment of the device can be obtained, since a positional relationship with respect to the device cannot be known only with the information, it is not easy to construct an accurate three-dimensional model of the device and the surrounding environment in the virtual space. Therefore, it takes a lot of time and effort to start a so-called offline simulation using a simulation device, which hinders rapid development of a control program for the device.

Therefore, there has been a demand for a method that enables a simulation device to efficiently acquire a model of a device and a surrounding environment of the device.

An information processing system, a robot system, an information processing method, and the like according to embodiments of the present invention will be described with reference to the drawings. The embodiments described below are merely examples, and for example, detailed configurations can be appropriately changed and implemented by those skilled in the art without departing from the gist of the present invention.

In the drawings referred to in the following embodiments and description, elements denoted by the same reference signs have the same functions unless otherwise specified. In addition, the drawings may be schematic for convenience of illustration and description, and thus, the shape, size, arrangement, and the like in the drawings do not necessarily strictly match with those of the actual object.

### First Embodiment

### Configuration of Information Processing System

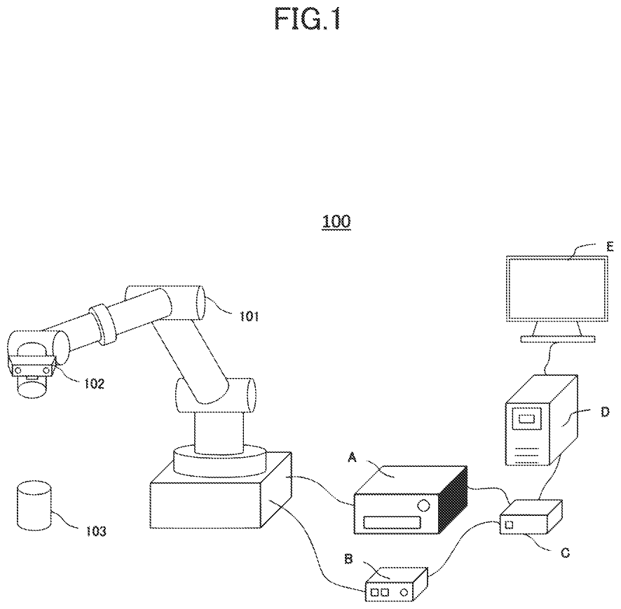

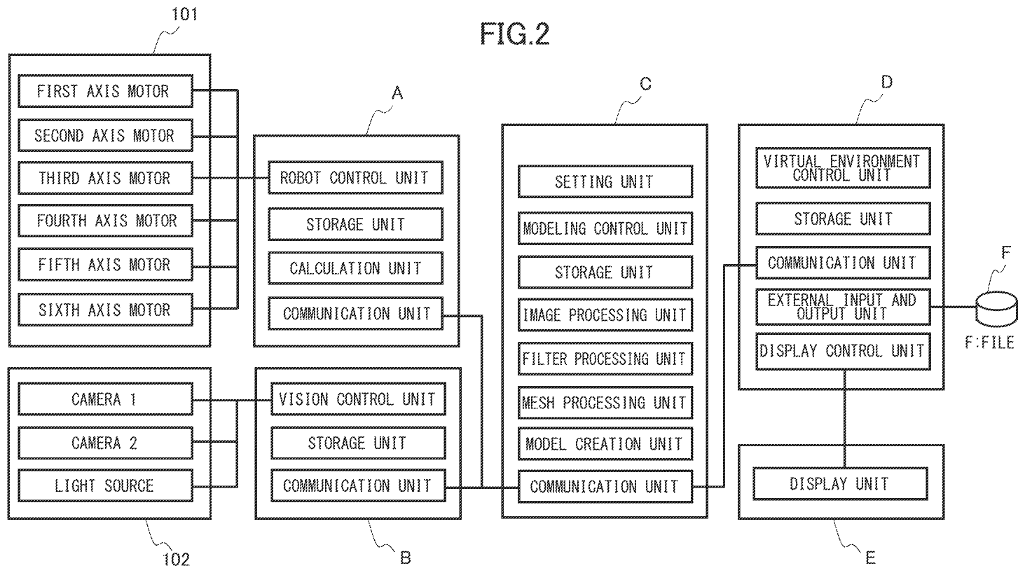

FIG. 1 is a schematic diagram illustrating a schematic configuration of an information processing system 100 (robot system) according to a first embodiment. Furthermore, FIG. 2 is a functional block diagram for describing a configuration of the information processing system 100. In FIG. 2, functional elements necessary for describing characteristics of the present embodiment are represented by functional blocks, but a description of general functional elements not directly related to the principle for solving the problems according to the present invention is omitted. In addition, each functional element illustrated in FIG. 2 is functionally conceptual, and does not necessarily have to be physically configured as illustrated. For example, a specific form of distribution or integration of the functional blocks is not limited to the illustrated example, and all or some of the functional blocks can be functionally or physically distributed and integrated in arbitrary units according to a use situation or the like. Each functional block can be configured using hardware or software.

Reference sign 101 denotes a robot as a device including a movable unit, Reference sign 102 denotes a vision sensor as a measurement unit, Reference sign 103 denotes a model creation target as a measurement target, and Reference sign A denotes a robot control device that controls the robot 101. Reference sign B denotes a vision sensor control device that controls the vision sensor 102, Reference sign C denotes a model creation device, Reference sign D denotes a simulation device, and Reference sign E denotes a display device.

The information processing system 100 of the present embodiment measures the model creation target 103 by using the vision sensor 102 as the measurement unit mounted on the robot 101. Then, a three-dimensional model for simulation is automatically created using a measurement result and stored in the simulation device D as a simulation unit. The model creation target 103 is an object existing in a surrounding environment of the robot 101, and is an object for which a three-dimensional model (virtual model) for simulation has not yet been created. Examples of the model creation target 103 include, but are not limited to, an object existing in a movable range of the robot 101, such as a device cooperating with the robot 101 (a part conveying device, a processing device, or the like), and a structure such as a wall or a column.

The robot 101 illustrated in FIG. 1 as the device having the movable unit is a six-axis articulated robot, but the robot 101 may be a robot or a device of another type. For example, the robot 101 may be a device including a movable unit capable of performing operations of expansion and contraction, bending and stretching, vertical movement, horizontal movement, or turning, or a combined operation thereof.

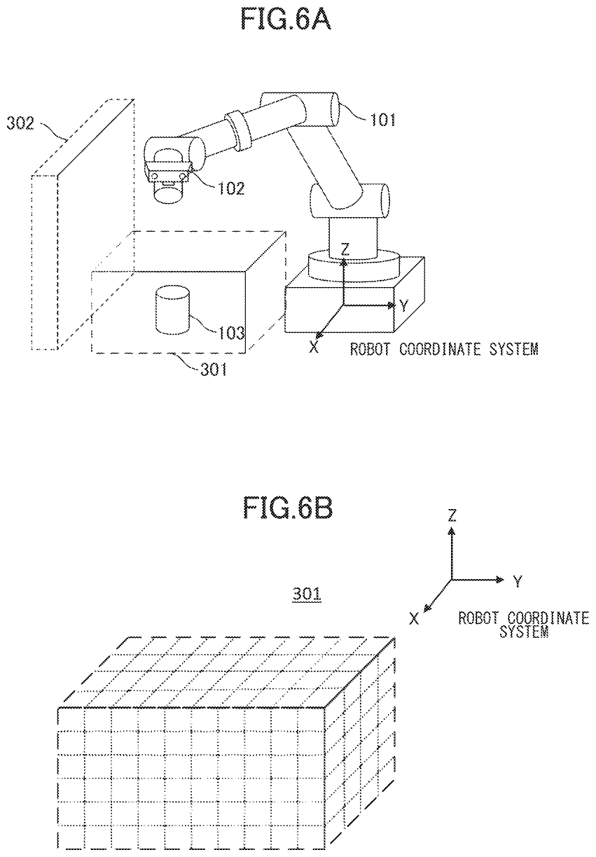

The vision sensor 102 is an imaging device mounted at a predetermined position suitable for imaging the surrounding environment of the robot 101, such as an arm distal end portion or a hand of the robot 101. In order to enable association between a captured image (measurement result) and a robot coordinate system, it is desirable that the vision sensor 102 is firmly fixed to the movable unit of the robot 101, but the vision sensor 102 may also be temporarily fixed in a detachable manner as long as positioning accuracy is ensured. The robot coordinate system is a three-dimensional coordinate system (X, Y, Z) in which a non-moving portion (for example, a base) in the installed robot is set as an origin (see FIG. 6A).

The vision sensor 102 as a measurement device may be any device as long as image data (or three-dimensional measurement data) suitable for creation of a three-dimensional model can be acquired, and for example, a stereo camera with an illumination light source is used as appropriate. In addition, a device capable of acquiring three-dimensional point cloud data based on the robot coordinate system suitable for creating a three-dimensional model by measurement is not limited to a stereo camera, and for example, monocular cameras may be used to image an object from a plurality of locations with convergence (parallax) to acquire the three-dimensional measurement data. Furthermore, instead of an imaging sensor, for example, a light detecting ranging scanner (LiDAR scanner) capable of measuring an object shape by using a laser beam may be used as the measurement device. In the following description, imaging using the vision sensor 102 may be referred to as measurement.

The robot control device A has a function of generating operation control information for operating each joint of the robot 101 according to a command related to a position and posture of the robot 101 transmitted from the model creation device C, and controlling the operation of the robot 101.

The vision sensor control device B generates a control signal for controlling the vision sensor 102 based on a measurement command transmitted from the model creation device C, and transmits the control signal to the vision sensor 102. At the same time, the vision sensor control device B has a function of transmitting measurement data output from the vision sensor 102 to the model creation device C.

The model creation device C has a function of transmitting a command to the robot control device A to move the robot 101 to a predetermined position and posture (measurement point) for measuring the model creation target 103, and transmitting a command to the vision sensor control device B to cause the vision sensor 102 to measure the model creation target 103, and acquire measurement data. Further, the model creation device C has a function of generating a three-dimensional model of the model creation target 103 by using the acquired measurement data, and storing the generated three-dimensional model in the simulation device D together with position information based on the robot coordinate system. A three-dimensional model generation procedure will be described in detail below.

The simulation device D as the simulation unit constructs a virtual model of the robot 101 and the surrounding environment of the robot 101 on a virtual space by using the three-dimensional model acquired from the model creation device C and the position information. Then, the simulation device D has a function of performing offline simulation for the robot 101. The simulation device D has a function of causing the display device E to appropriately display the three-dimensional model created by the model creation device C, the virtual model of the robot 101 and the surrounding environment of the robot 101, information regarding the offline simulation, and the like. The simulation device D can also cause the display device E to display information acquired from the robot control device A, the vision sensor control device B, and the model creation device C via the communication unit.

The display device E as a display unit is a display used as a user interface of the simulation device D. For example, a direct-view flat panel display such as a liquid crystal display device or an organic EL display device, a projection display, a goggle-type stereo display, a holographic display, or the like can be used. Furthermore, the information processing system of the present embodiment can include an input device (not illustrated) such as a keyboard, a jog dial, a mouse, a pointing device, or a voice input device.

In FIG. 1, the robot 101, the robot control device A, the vision sensor 102, the vision sensor control device B, the model creation device C, the simulation device D, and the display device E are connected by wired communication, but the present invention is not limited thereto. For example, some or all of them may be connected by wireless communication, or may be connected via a general-purpose network such as a LAN or the Internet.

Each of the robot control device A, the vision sensor control device B, the model creation device C, and the simulation device D is a computer that executes each function described above. In FIG. 1, these devices are illustrated as separate devices, but some or all of the devices can be integrated.

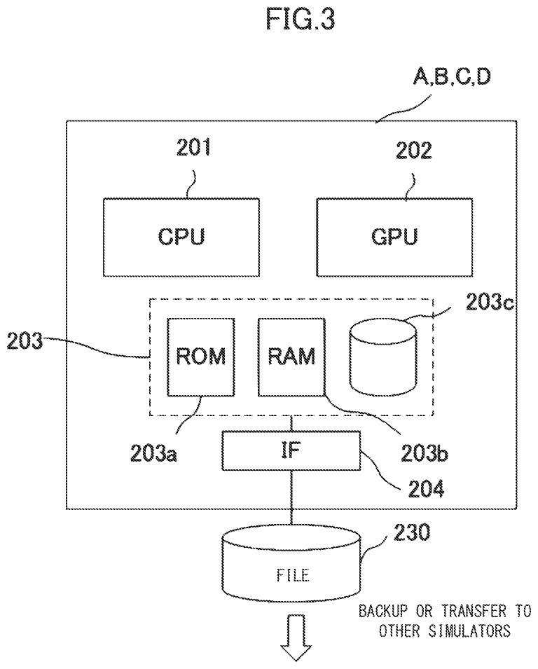

Each of these devices has, for example, the configuration illustrated in FIG. 3. That is, each device includes a central processing unit (CPU) 201 which is a processor, a storage unit 203, and an input and output interface 204. Each device can also include a graphics processing unit (GPU) 202 as necessary. The storage unit 203 includes a read only memory (ROM) 203a, a random-access memory (RAM) 203b, and a hard disk drive (HDD) 203c. The CPU 201, the GPU 202, the storage unit 203, and the input and output interface 204 are connected by a bus line (not illustrated) in such a way as to be able to communicate with each other.

The ROM 203a included in the storage unit 203 is a non-transitory storage device, and stores a basic program read by the CPU 201 at the time of starting of the computer. The RAM 203b is a transitory storage device used for arithmetic processing of the CPU 201. The HDD 203c is a non-transitory storage device that stores various data such as a processing program executed by the CPU 201 and an arithmetic processing result of the CPU 201. Here, the processing program executed by the CPU 201 is a processing program for each device to execute the above-described function, and at least some of the functional blocks illustrated in FIG. 2 can be implemented in each device by the CPU 201 executing the program. For example, in a case of the model creation device C, functional blocks such as a setting unit, a modeling control unit, an image processing unit, a filter processing unit, a mesh processing unit, and a model creation unit can be implemented by the CPU 201 executing the processing program. However, a functional block that performs typical processing related to image processing may be implemented by the GPU 202 instead of the CPU 201 in order to speed up the processing.

Other devices and networks can be connected to the input and output interface 204. For example, data can be backed up in a database 230, or information such as commands and data can be exchanged with other devices.

### Three-Dimensional Model Generation and Simulation

A three-dimensional model generation procedure using the information processing system 100 will be described. Preparation for measurement, measurement, generation of a three-dimensional model, and simulation using the three-dimensional model will be sequentially described.

### Preparation for Measurement

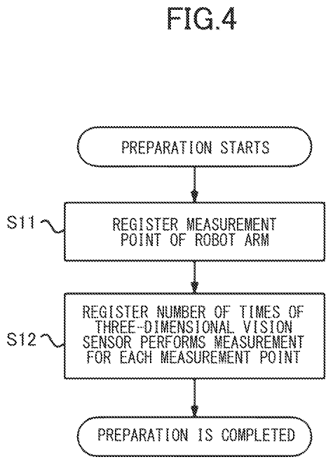

As illustrated in FIG. 1, a preparation step of measuring the model creation target 103 by using the vision sensor 102 is performed in a state where the positions of the robot 101 and the model creation target 103 are fixed. FIG. 4 is a flowchart for describing a procedure of the preparation for measurement.

Once the measurement preparation step starts, in step S11, an operator registers a measurement position and a measurement posture to be taken by the robot 101 when the vision sensor 102 images the model creation target 103 in the model creation device C. In the following description, the measurement position and the measurement posture may be collectively referred to as a measurement point.

A first method for registering the measurement points is a method in which the operator operates the robot 101 online and registers a plurality of (for example, N) measurement points around the model creation target 103 as setting information. At this time, an image captured by the vision sensor 102 may be displayed on the display device E, and the operator may set the measurement points while confirming the image.

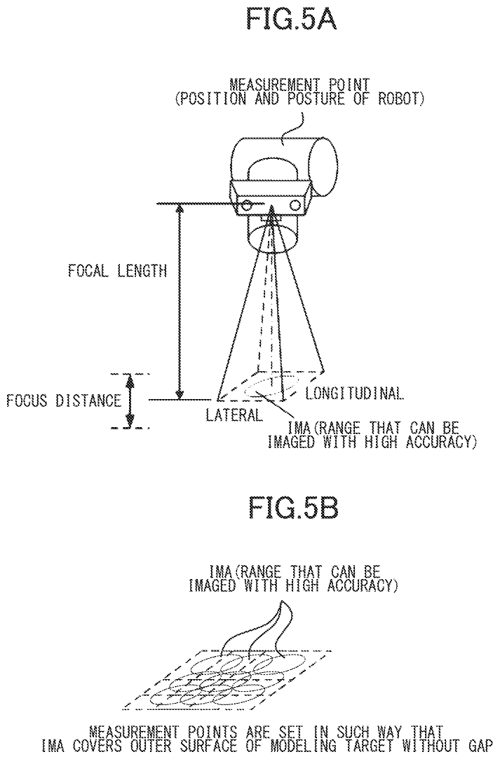

As illustrated in FIG. 5A, a measurement range IMA (imaging range) that can be accurately measured (imaged) by the vision sensor 102 (for example, a stereo camera) is limited to a certain narrow range in consideration of a depth of field and image distortion. Therefore, as illustrated in FIG. 5B, it is necessary to set the measurement points in such a way that the measurement range IMA covers an outer surface of the model creation target 103 without a gap in order to generate an accurate three-dimensional model. Therefore, in the first method, it is necessary that a skilled operator performs the work, and a workload and a required time tend to increase.

Therefore, in a second method for registering the measurement points, as illustrated in FIG. 6A, first, the operator sets a measurement target area 301 (imaging target area) as the setting information in such a way as to include the model creation target 103. Then, as schematically illustrated in FIG. 6B, the model creation device C divides the measurement target area 301 (imaging target area) by squares in such a way that the measurement range IMA that can be accurately imaged by the vision sensor 102 covers the measurement target area 301 without a gap. Then, a position and posture to be taken by the robot 101 to image each measurement range IMA are automatically set and registered as the measurement point. The operator can set in advance a movement-prohibited area 302 to which the robot 101 is prohibited from moving together with the measurement target area 301 (imaging target area). In this case, the model creation device C does not set a measurement point to which the robot 101 needs to move in the movement-prohibited area 302. The model creation device C may be configured in such a way that the operator can set the measurement target area 301 and/or the movement-prohibited area 302 while displaying the image captured by the vision sensor 102 on the display device E.

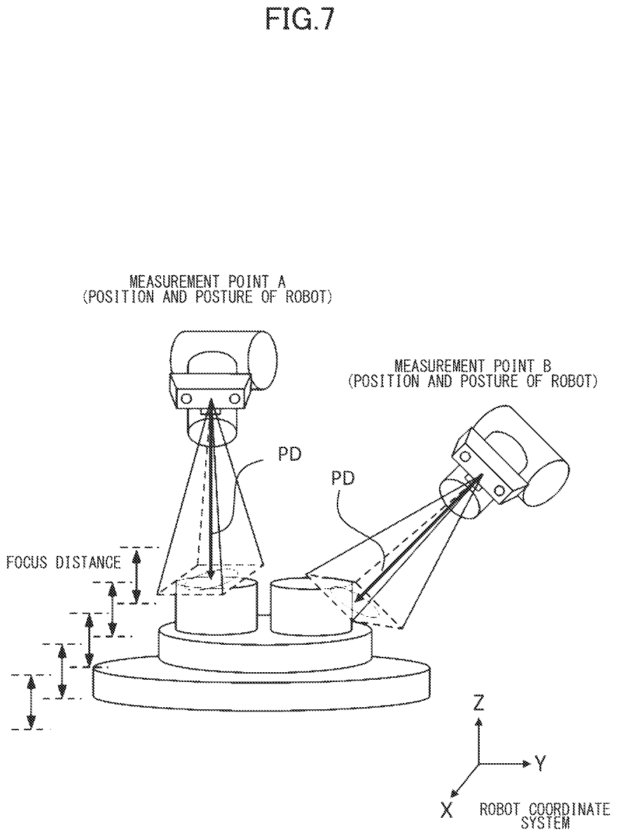

As illustrated in FIG. 7, not only a measurement point A whose measurement direction PD (imaging direction) is along a Z direction but also a measurement point B whose measurement direction PD (imaging direction) is rotated around an X axis or a Y axis are set in order to appropriately detect external characteristics such as an edge and a recess according to the shape of the model creation target. In this case, a setting condition (for example, a width of a divided area or the number of divided areas in a case where the measurement target area 301 is divided in each of the X, Y, and Z directions) for the measurement point A and a setting condition (for example, rotation angles around the X axis and the Y axis or the number of types of rotation angles used for measurement) for the measurement point B may be set in advance by the operator, and the model creation device C may automatically generate the measurement point A and/or the measurement point B based on the setting.

In the first method or the second method, the plurality of (N) measurement points set based on installation information input by the operator are registered in the setting unit of the model creation device C. The model creation device C may be configured to display a plurality of set measurement points on the display device E so that the operator can confirm or edit the measurement points.

Once the registration of the measurement points is completed in step S11, the processing proceeds to step S12, and the operator sets the number of times measurement (imaging) is performed at each measurement point. If measurement data (imaging data) for generating a three-dimensional model can be reliably acquired by performing the measurement (imaging) once, it is sufficient that the measurement (imaging) is performed once at each measurement point. However, the captured image may change depending on a material, shape, and surface state of the model creation target, a state of external light reaching the model creation target, or the like. For example, in a case where the model creation target is formed of a glossy material such as metal, or an uneven portion or texture exists in the model creation target, the luminance distribution, the contrast, the appearance of the uneven portion or texture, and the like change depending on the state of external light, and thus, there is a possibility that measurement data (imaging data) suitable for generating a three-dimensional model cannot be acquired by performing the imaging (measurement) once. In particular, in a case where a stereo camera is used as the vision sensor 102, since both eyes form a convergence, measurement data (imaging data) tends to be easily affected by the state of external light or the like.

Therefore, in the present embodiment, the operator can set the number of times of measurement M in such a way as to perform measurement (imaging) a plurality of times at each measurement point in consideration of the appearance characteristics of the model creation target and the state of external light so that the point cloud data to be described below can be taken without omission. In a case where the vision sensor 102 with an illuminating light source is used, an operation condition (for example, an illumination intensity or an illumination direction) of the illuminating light source may be set to be changed in each imaging. The result set in step S12 is registered in the setting unit of the model creation device C. The model creation device C may be configured to display an operation screen at the time of performing these settings, the set number of times, and the like on the display device E so that the operator can confirm or edit the operation screen, the set number of times, and the like. Once step S12 is completed, the preparation step of measuring (imaging) the model creation target 103 ends.

### Measurement

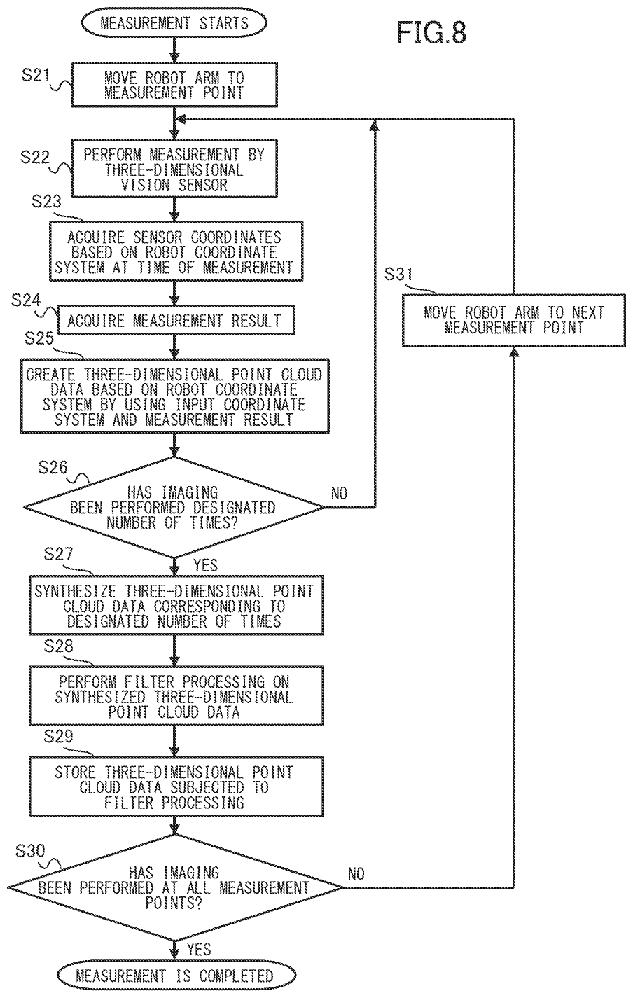

After the measurement preparation step ends, a measurement step (imaging step) of measuring (imaging) the model creation target 103 by using the vision sensor 102 is performed. FIG. 8 is a flowchart for describing a measurement (imaging) procedure.

Once the measurement (imaging) starts, in step S21, the model creation device C reads one of the plurality of measurement points registered in the setting unit, and transmits a command to the robot control device A via the communication unit in such a way as to move the robot 101 to the measurement point. The robot control device A interprets the received command and moves the robot 101 to the measurement point.

Next, in step S22, the model creation device C transmits a command to the vision sensor control device B via the communication unit in such a way as to cause the vision sensor 102 to perform measurement (imaging). The vision sensor control device B interprets the received command and causes the vision sensor 102 to perform measurement (imaging).

Next, in step S23, the model creation device C requests the robot control device A to transmit the position of the vision sensor 102 at the time of measurement (imaging) as position information based on the robot coordinate system with the robot 101 as the origin. The modeling control unit of the model creation device C stores the position information received via the communication unit in the storage unit.

Next, in step S24, the model creation device C requests the vision sensor control device B to transmit a measurement result (imaging result) obtained by the vision sensor 102. The modeling control unit of the model creation device C stores the measurement result (imaging result) received via the communication unit in the storage unit in association with the position information acquired from the robot control device A.

Next, in step S25, the image processing unit of the model creation device C acquires three-dimensional point cloud data expressed based on the robot coordinate system by using the measurement result (imaging result) associated with the position information of the vision sensor 102 expressed based on the robot coordinate system. The three-dimensional point cloud data is point cloud data related to an appearance of the model creation target 103 measured at the measurement point, and each piece of point data included in the three-dimensional point cloud data has position information (spatial coordinates) expressed based on the robot coordinate system. The three-dimensional point cloud data acquired by the image processing unit is stored in the storage unit of the model creation device C.

Next, in step S26, the model creation device C determines whether or not the measurement (imaging) is completed at the measurement point based on the number of times of measurement M set in step S12. In a case where the measurement (imaging) of the set number of times is not completed (step S26: NO), the processing returns to step S22, and the processing of step S22 and subsequent processings are performed again at the measurement point. In a case where the measurement (imaging) of the set number of times is completed (step S26: YES), the processing proceeds to step S27.

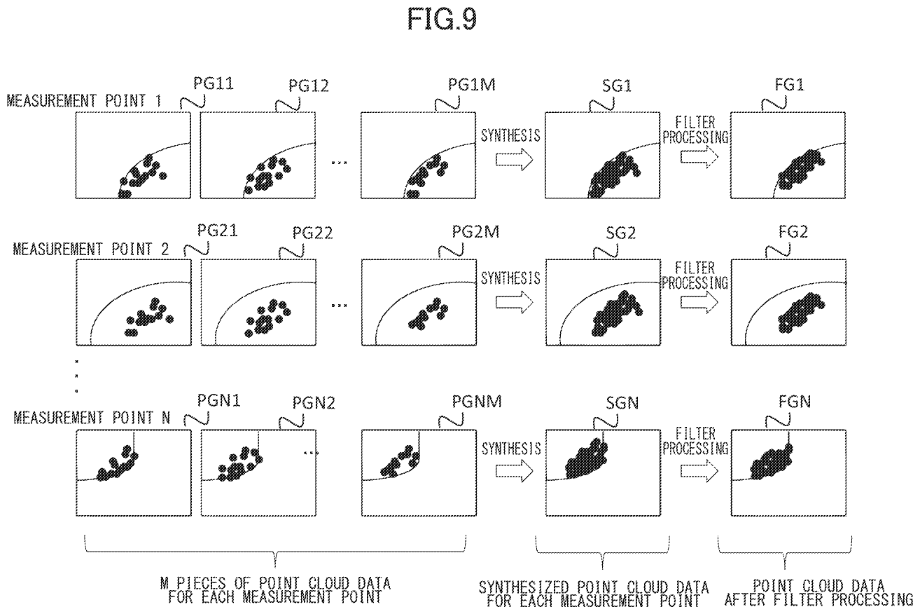

In step S27, the image processing unit of the model creation device C reads M pieces of point cloud data acquired at the measurement point from the storage unit, and synthesizes (superimposes) the M pieces of point cloud data. For example, in a case where the measurement point is measurement point 1, as illustrated in FIG. 9, M pieces of point cloud data of PG11 to PG1M are superimposed to generate synthesized point cloud data SG1 including all the pieces of point cloud data acquired at measurement point 1. The synthesis (superimposition) of the M pieces of point cloud data can be performed using known image synthesis software.

Next, in step S28, the filter processing unit of the model creation device C performs filter processing on the synthesized point cloud data generated in step S27 to remove noise, and generates partial point cloud data for model creation. That is, for example, in a case where the measurement point is measurement point 1, as illustrated in FIG. 9, noise is removed by performing filter processing on the synthesized point cloud data SG1, and partial point cloud data FG1 for model creation is generated. The filter processing can be performed using, for example, Open3D which is known open-source software, and may be performed by other methods.

Next, in step S29, the image processing unit of the model creation device C stores the partial point cloud data for model creation generated in step S28 in the storage unit.

Next, in step S30, the modeling control unit of the model creation device C determines whether or not the storage of the partial point cloud data for model creation is completed for all the N measurement points. In a case where the number of measurement points for which the storage is completed is less than N (step S30: NO), the processing proceeds to step S31, and the model creation device C newly reads another measurement point from the N measurement points registered in the setting unit, and transmits a command to the robot control device A via the communication unit in such a way as to move the robot 101 to the measurement point. Then, the processing of step S22 and subsequent processings are performed again.

In a case where it is determined in step S30 that the storage of the partial point cloud data for model creation is completed for all the N measurement points (step S30: YES), the measurement step (imaging step) ends.

The number of targets whose interference with the robot 101 is to be verified, in other words, the number of model creation targets existing within the movable range of the robot 101 is not limited to one as illustrated in FIG. 1. In a case where a plurality of model creation targets exists, the measurement processing for all the model creation targets may be collectively performed according to the processing procedure illustrated in FIG. 8, or the measurement processing may be separately performed for each model creation target.

### Three-Dimensional Model Generation and Simulation

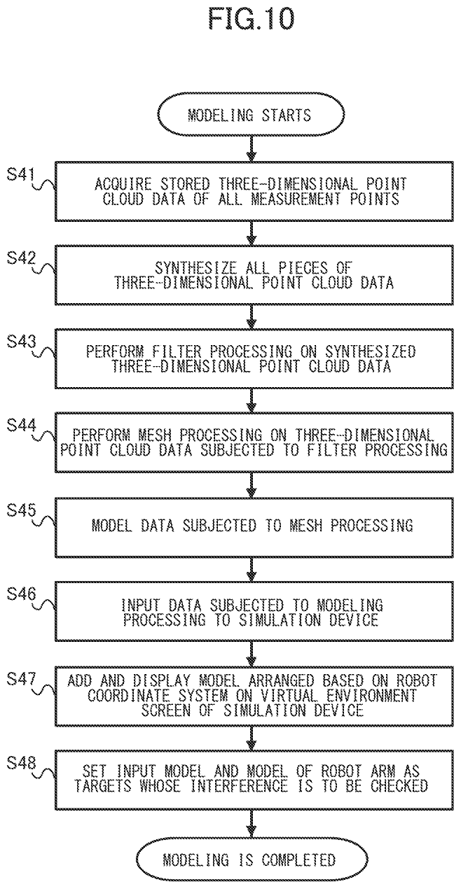

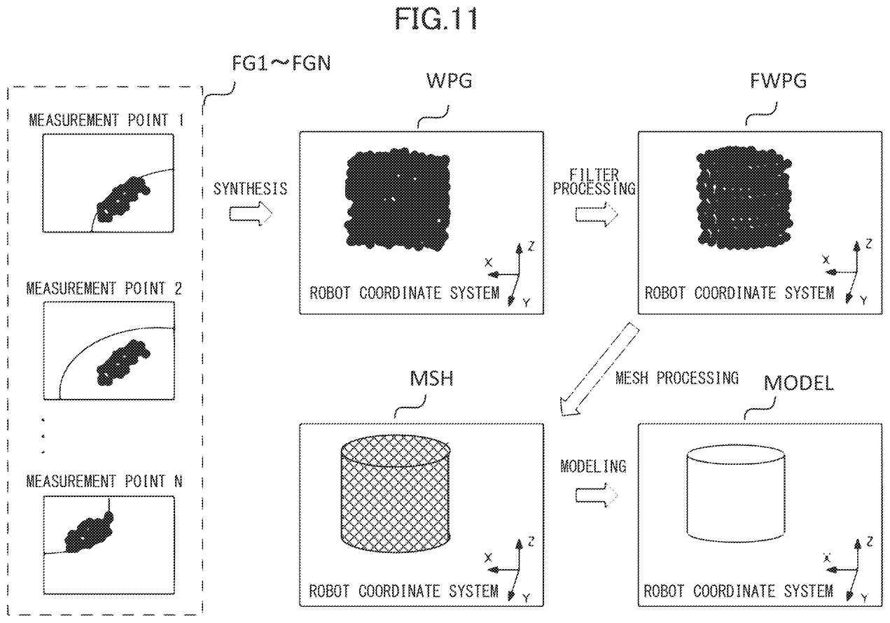

A procedure for generating a three-dimensional model of the model creation target 103 by using the partial point cloud data that is the measurement result (imaging result) and performing offline simulation will be described. FIG. 10 is a flowchart for describing the three-dimensional model generation procedure. FIG. 11 is a schematic diagram for describing transition of data in each step of model generation.

Once the model generation starts, in step S41, the model creation unit of the model creation device C reads pieces of partial point cloud data FG1 to FGN for model creation stored in the storage unit. In FIG. 11, the read pieces of partial point cloud data FG1 to FGN are schematically illustrated by being surrounded by a dotted line on the left side.

Next, in step S42, the model creation unit of the model creation device C superimposes and synthesizes the read pieces of partial point cloud data based on the robot coordinate system. That is, the entire point cloud data WPG related to the entire appearance of the model creation target 103 is synthesized using the pieces of partial point cloud data FG1 to FGN acquired at each measurement point. The entire point cloud data WPG can be synthesized from the pieces of partial point cloud data by using known image synthesis software.

Next, in step S43, the filter processing unit of the model creation device C performs filter processing on the entire point cloud data WPG generated in step S42 to remove noise, and generates point cloud data FWPG for model creation as illustrated in FIG. 11. The filter processing can be performed using, for example, Open3D which is known open-source software, and may be performed by other methods.

Next, in step S44, the mesh processing unit of the model creation device C performs mesh processing on the point cloud data FWPG to acquire mesh information MSH, that is, polygon information that is an aggregate of triangular polygons. The mesh processing can be performed using, for example, MeshLab which is known open-source software, and may be performed by other methods. The model creation device C may be configured to display the generated mesh information MSH on the display device E based on the robot coordinate system so that the operator can confirm the mesh information MSH.

Next, in step S45, the model creation unit of the model creation device C creates a contour line such as an edge appearing in the appearance of the model creation target 103 by using the mesh information MSH, and creates a surface model. In a case where a solid model including not only a surface (outer surface) of the model creation target 103 but also a volume (inside) is required, the solid model can be generated based on the surface model. A three-dimensional model MODEL generated based on the robot coordinate system is stored in the storage unit of the model creation device C. The creation of the three-dimensional model using the mesh information MSH can be performed using, for example, QUICKSURFACE, which is 3D modeling software manufactured by System Create Co., Ltd., and may be performed by other methods. The model creation device C may be configured to display the generated three-dimensional model MODEL on the display device E based on the robot coordinate system, so that the operator can confirm the appropriateness/inappropriateness of the three-dimensional model MODEL.

Next, in step S46, the model creation device C transmits data of the generated three-dimensional model MODEL to the simulation device D via the communication unit. The simulation device D stores the received data of the three-dimensional model MODEL in the storage unit. In addition, the simulation device D can format the data of the three-dimensional model MODEL and store the data as a backup file F in an external database via an external input and output unit.

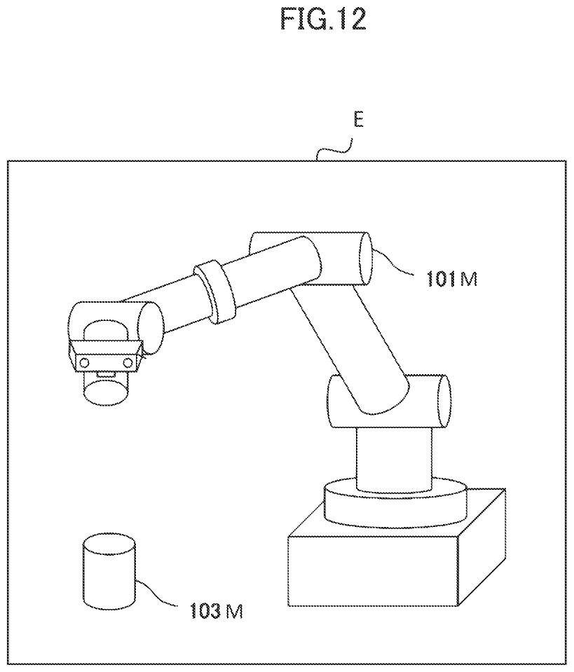

Next, in step S47, a virtual environment control unit of the simulation device D uses the data of the three-dimensional model MODEL to generate a virtual environment model in which the target is arranged based on the robot coordinate system. Then, for example, as illustrated in FIG. 12, a situation in which a virtual model 101M of the robot 101 and a virtual model 103M of the surrounding environment are arranged in a correct positional relationship in the virtual space can be displayed to the operator by using the display device E.

Next, in step S48, the simulation device D automatically sets and registers the virtual model 103M of the surrounding environment as a target whose interference with the robot 101 is to be checked. The simulation device D may be configured in such a way that the operator can select and register the target whose interference with the robot 101 is to be checked with reference to the virtual environment model displayed on the display device E. In this way, the construction of the virtual model of the surrounding environment of the robot 101 is completed, and preparation for performing a simulation such as interference checking offline is done.

The operator can perform an offline simulation by using the simulation device D and operate the virtual model 101M of the robot 101 in the virtual space to check execution of the work and the presence or absence of interference with the surrounding environment. For example, a production line in which the robot is installed is virtually modeled by the above-described procedure, and a work operation (for example, assembling of parts, setting of a part in a processing device, movement of a part, and the like) to be performed by the robot is performed by the virtual model of the robot in the virtual space, so that the presence or absence of interference with the surrounding environment and the execution of the work can be examined. Control data related to the work operation of the robot verified as described above is transmitted from the simulation device D to the robot control device A via the communication unit, and can be stored in the robot control device A as training data. The robot control device A can cause the robot 101 to perform the work operation (for example, assembling of parts, setting of a part in a processing device, movement of a part, and the like) trained in this way and cause the robot 101 to manufacture an article. An article manufacturing method performed in such a procedure can also be included in the present embodiment.

In the present embodiment, the measurement device (imaging device) fixed to the movable unit of the robot is used to measure (image) a model creation target while operating the robot, and point cloud data of the model creation target based on the robot coordinate system is acquired. Then, since a 3D model of the target is generated based on the point cloud data, modeling can be performed including not only three-dimensional shape information of the target but also position information with respect to the robot. Therefore, after the three-dimensional shape model of the target is created, the operator does not need to perform positioning of the virtual target model with respect to the virtual robot model in the virtual space, and a virtual model of the work environment of the robot can be efficiently constructed.

As the information processing system of the present embodiment is used, for example, at the time of forming a new manufacturing line, after installing the robot at a position where a predetermined operation is performed in the manufacturing line, the surrounding environment is measured using the robot, and a virtual model of the surrounding environment can be easily constructed in the simulation device. Alternatively, in an existing manufacturing line in which the robot is installed, in a case where the type or position of a device installed around the robot is changed in order to change a work content, the device is measured using the robot. Then, a virtual model of the changed surrounding environment can be easily constructed in the simulation device. According to the present embodiment, since a simulation model of the surrounding environment of the robot can be easily created, an offline simulation work for the robot using the simulation device can be started in a short time.

### Second Embodiment

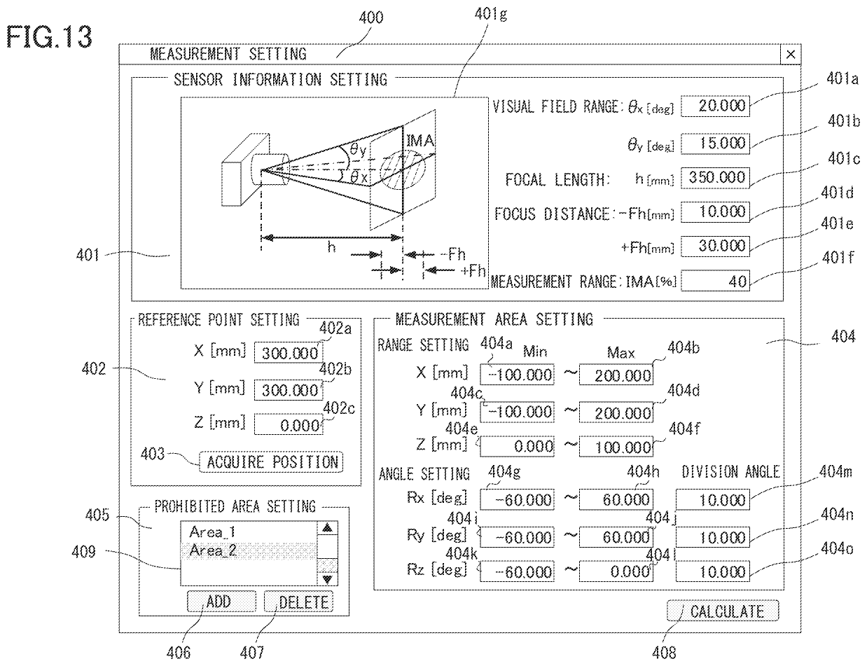

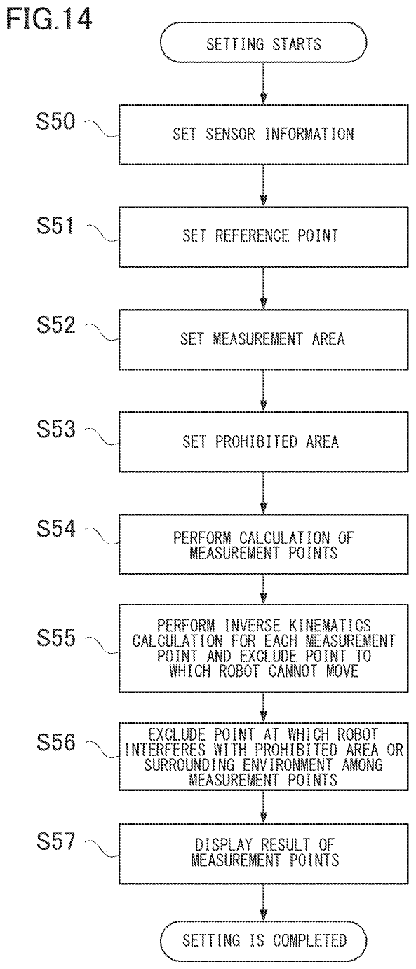

A second embodiment specifically describes in detail a method for automatically generating measurement points described in the first embodiment. A description of matters common to the first embodiment will be simplified or omitted. FIG. 13 is a view for describing a measurement setting screen 400 according to the second embodiment, and FIG. 14 is a flowchart of automatic generation of the measurement points according to the second embodiment.

As illustrated in FIG. 13, a sensor information setting section 401, a reference point setting section 402, a measurement area setting section 404, a movement-prohibited area setting section 405, and a calculation button 408 are displayed on the measurement setting screen 400. Although not illustrated in FIG. 13, it is assumed that a virtual space described below is also displayed on a separate screen.

The sensor information setting section 401 displays numerical value setting fields for visual field ranges θx and θy of a sensor for measuring a surrounding area of a robot, a focal length h, a focus distance ±Fh, and a measurement range IMA. The visual field range θx can be set in a numerical value setting field 401a. The visual field range θy can be set in a numerical value setting field 401b. The focal length h can be set in a numerical value setting field 401c. The focus distance −Fh can be set in a numerical value setting field 401d. The focus distance +Fh can be set in a numerical value setting field 401e. The measurement range IMA can be set in a numerical value setting field 401f. In addition, in a sensor display section 401g, the sensor is schematically displayed, and setting information of the sensor to which numerical values set in the numerical value setting fields correspond is illustrated. As a result, the user can easily set a measurement condition in the sensor according to the surrounding area of the robot.

The reference point setting section 402 displays numerical value setting fields 402a, 402b, and 402c in which values of X, Y, and Z can be input, and is provided with a position acquisition button 403.

The measurement area setting section 404 displays numerical value setting fields in which minimum values Min and maximum values Max of range settings X, Y, and Z and angle settings Rx, Ry, and Rz can be input as measurement range setting for the sensor. In a numerical value setting field 404a, the minimum value of the value of X can be set, and in a numerical value setting field 404b, the maximum value of the value of X can be set. In a numerical value setting field 404c, the minimum value of the value of Y can be set, and in a numerical value setting field 404d, the maximum value of the value of Y can be set. In a numerical value setting field 404e, the minimum value of the value Z can be set, and in a numerical value setting field 404f, the maximum value of the value Z can be set. In a numerical value setting field 404g, the minimum value of the value of Rx can be set, and in a numerical value setting field 404h, the maximum value of the value of Rx can be set. In a numerical value setting field 404i, the minimum value of the value of Ry can be set, and in a numerical value setting field 404j, the maximum value of the value of Ry can be set. In a numerical value setting field 404k, the minimum value of the value of Rz can be set, and in a numerical value setting field 404l, the maximum value of the value of Rz can be set. Further, in the angle settings Rx, Ry, and Rz, division angles of the measurement range can be set. The division angle of Rx can be set in a numerical value setting field 404m. The division angle of Ry can be set in a numerical value setting field 404n. The division angle of Rz can be set in a numerical value setting field 404o.

The movement-prohibited area setting section 405 is provided with a list 409 that displays a set movement-prohibited area, and an addition button 406 and a deletion button 407 for a movement-prohibited area selected in a virtual space. The area displayed in the list 409 is an area where the sensor is prohibited from entering at the time of performing the measurement. In the second embodiment, it is possible to automatically generate measurement points covering a necessary measurement area by performing an operation procedure described below.

As illustrated in FIG. 14, in step S50, sensor information is set using the measurement setting screen 400 described with reference to FIG. 13. Necessary information is input to the sensor information setting section 401. The minimum required sensor information includes the visual field ranges θx and θy and the focal length h of the sensor. Furthermore, in order to perform measurement with high accuracy, the focus distance ±Fh and the measurement range IMA are required.

Next, in step S51, a reference point is set. The values of X, Y, and Z of a reference place for the measurement are directly input to the reference point setting section 402, or a position selected in the virtual space for constructing the virtual model is set by pressing the acquisition button 403.

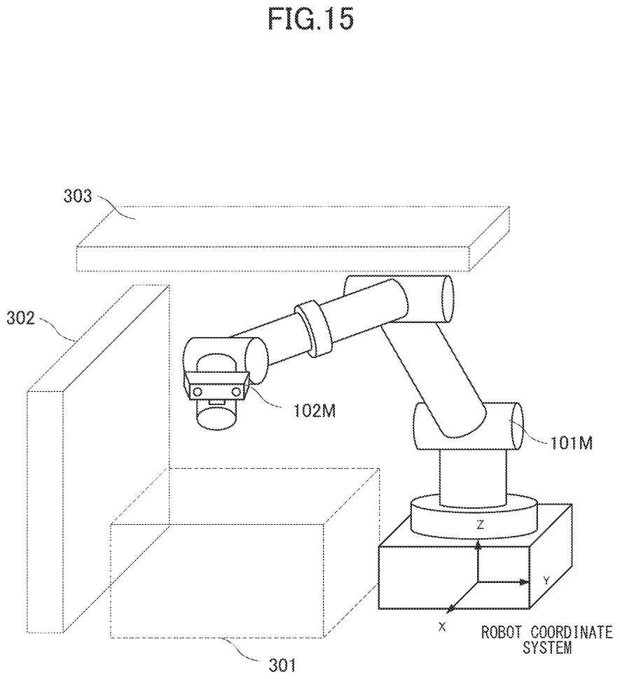

Next, in step S52, a measurement area is set. The measurement area setting section 404 inputs minimum values Min and maximum values Max of areas X, Y, and Z from the reference point. FIG. 15 is a view illustrating the measurement area displayed in the virtual space according to the second embodiment. By setting the measurement area, a measurement target area 301 corresponding to the input values is set around a virtual model 101M of a robot 101. In the real space, it is assumed that a target peripheral object exists in the measurement target area 301.

Next, in step S53, a movement-prohibited area in which movement of the sensor is prohibited at the time of performing the measurement is set. Each of movement-prohibited areas 302 (Area_1) and 303 (Area_2) displayed in the virtual space is selected, and the movement-prohibited area is registered by pressing the addition button 406 of the movement-prohibited area setting section 405. It is a matter of course that the user may set and register the movement-prohibited area by directly inputting a position in the virtual space. In a case of deleting a registered movement-prohibited area from the list, the movement-prohibited area to be deleted is selected from the list and the deletion button 407 is pressed to delete the movement-prohibited area. By performing the sensor information setting, the reference point setting, the measurement area setting, and the movement-prohibited area setting described above, preparation for automatic generation of the measurement points is done.

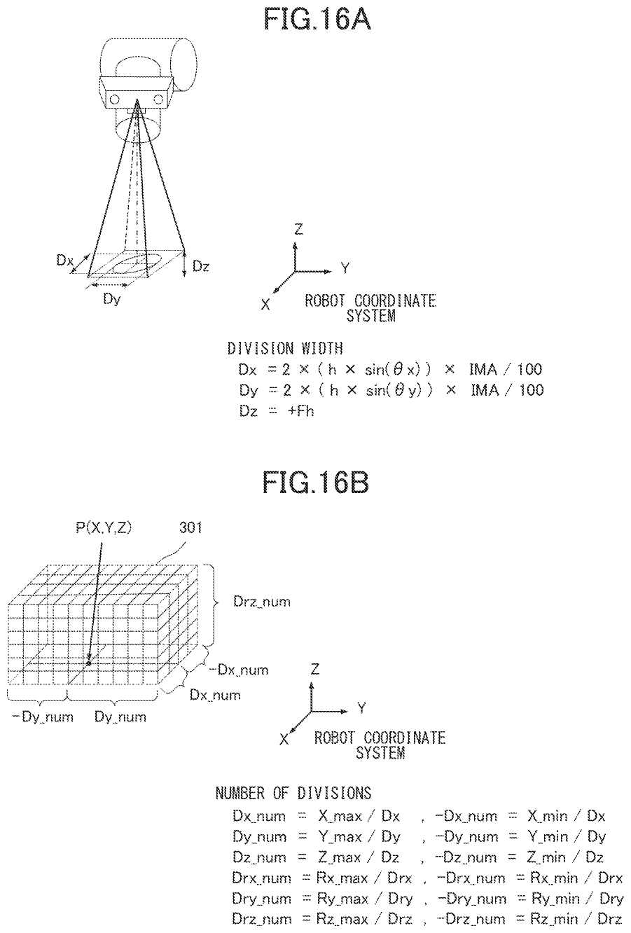

Next, in step S54, calculation of the measurement points is performed. Once the calculation button 408 is pressed, calculation processing is performed. FIGS. 16A and 16B are schematic views for describing automatic generation of the measurement points according to the second embodiment. FIG. 16A is a schematic view for describing a division width calculated from the sensor information. FIG. 16B is a schematic view for describing division of the measurement area.

As illustrated in FIG. 16A, division widths Dx and Dy of X and Y are calculated by calculating visual field ranges of X and Y with values that are twice the visual field ranges θx and θy of the sensor information and the focal length h, and multiplying by the measurement range IMA that is a range in which measurement can be performed with high accuracy. The focus distance +Fh is used as a division width Dz of Z. As illustrated in FIG. 16B, numbers obtained by dividing the minimum values Min and the maximum values Max of the measurement areas X, Y, and Z by the division widths Dx, Dy, and Dz acquired from the sensor information are the numbers of divisions, and the positions of the measurement points are acquired in a grid pattern for each division width calculated from the reference point (P). Next, the number of divisions of each angle is acquired from the measurement angles Rx, Ry, and Rz and the division angles Drx, Dry, and Drz, and each divided angle is given to each point of the positions set in a grid pattern, and the measurement point is automatically created.

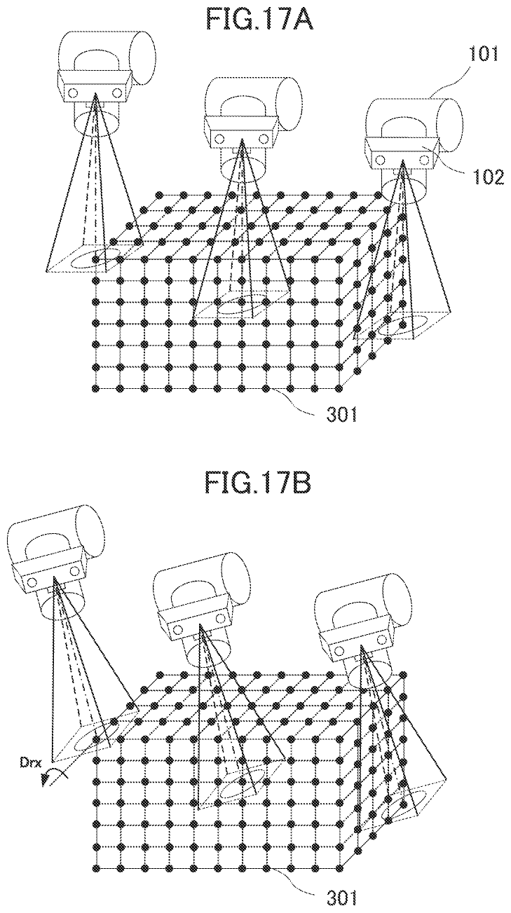

FIGS. 17A and 17B are schematic diagrams of postures of the robot 101 and a vision sensor 102 at the measurement points according to the second embodiment. FIG. 17A illustrates a state of measurement points corresponding to an angle of 0 degrees, and FIG. 17B illustrates a state of measurement points corresponding to a tilted angle of Drx in an X-axis direction.

Next, in step S55, inverse kinematics calculation is performed for each measurement point to exclude a point to which the robot 101 cannot move. Since the robot 101 has an operation range and cannot move to a point outside the operation range, the point is excluded. It is assumed that a known technique is used for the inverse kinematic calculation, and a detailed description thereof is omitted.

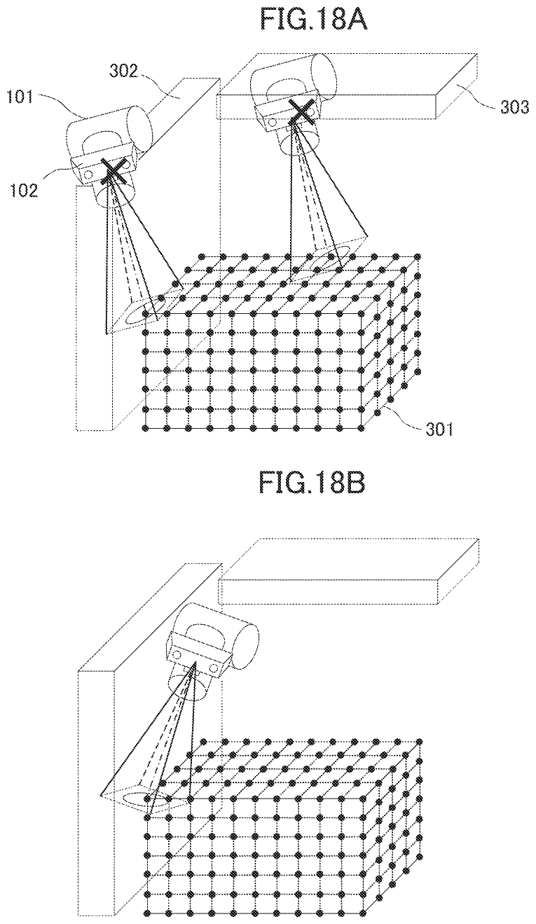

Next, in step S56, a point at which the robot interferes with the movement-prohibited area or the surrounding environment is excluded among the measurement points. FIGS. 18A and 18B are schematic views illustrating a state where an interference is checked for the measurement points according to the second embodiment. FIG. 18A illustrates a state where the movement-prohibited areas 302 and 303 and the robot 101 interfere with each other, and the measurement points are excluded. FIG. 18B illustrates a state of the robot whose angle is different for the same measurement point, and since there is no interference with the movement-prohibited area, the measurement point is not excluded. In this manner, the interference check is performed for all the measurement points, and a measurement point to which the robot cannot move is excluded in advance. The vision sensor 102 is set to take at least two different postures for each measurement point. By doing so, in a case where the robot taking a certain posture interferes with the movement-prohibited area for a certain measurement point, the robot does not interfere with the movement-prohibited area by changing the posture and can perform measurement at the measurement point. Therefore, it is possible to secure a certain number of measurement points while avoiding interference with the movement-prohibited area.

Next, in step S57, a result of the measurement points is displayed. The result is displayed as a list or a model in a virtual space, and in a case where a displayed measurement point is selected, the posture of the robot at the point can be confirmed in the virtual space.

As described above, according to the present embodiment, it is possible to automatically generate measurement points, and it is possible to perform measurement inside a movable measurement range. Therefore, it is possible to reduce a burden on the user caused by measurement of the surrounding environment of the robot by the robot and the sensor.

### Third Embodiment

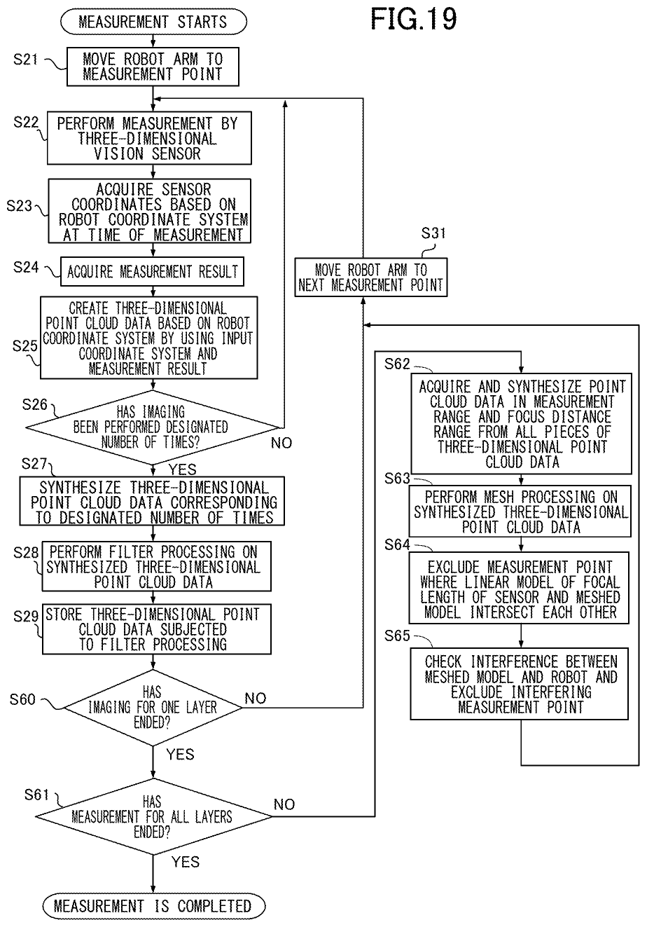

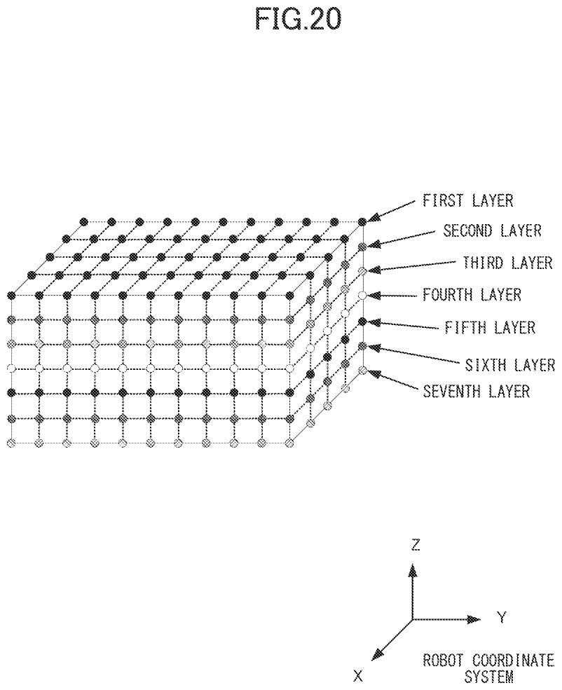

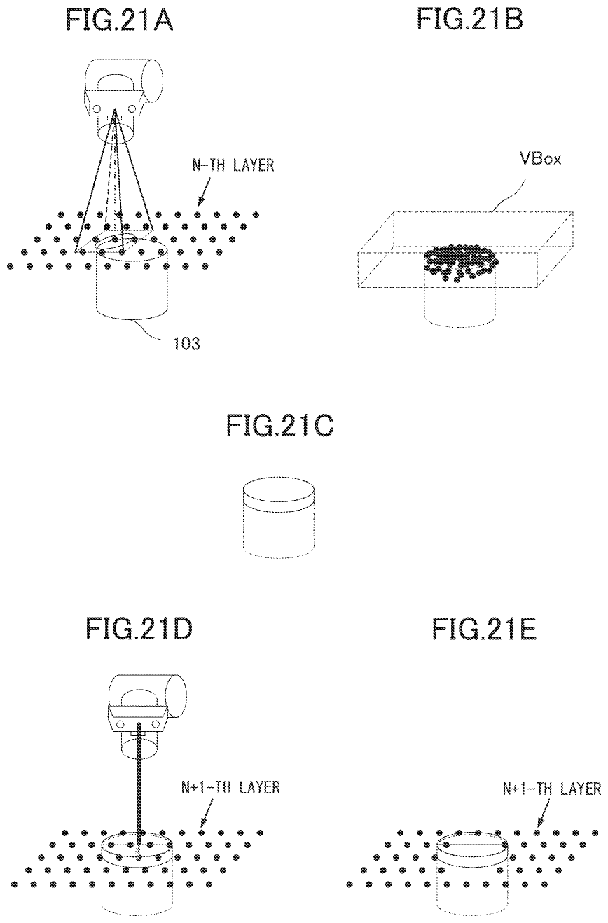

In the second embodiment, measurement points are automatically set, but the measurement points are also included in the model, which is useless. Therefore, in a third embodiment, a mode will be described in which it is determined whether or not a measurement point is a measurement point inside a model during measurement of a surrounding environment, and the measurement point inside the model is excluded. A description of matters common to the first and second embodiments will be simplified or omitted. FIG. 19 is a flowchart of a measurement method according to the third embodiment. FIG. 20 is a schematic view of a layer structure of measurement points according to the third embodiment. FIGS. 21A to 21E are schematic views for describing exclusion targets among measurement points according to the third embodiment.

First, FIG. 20 illustrates a state in which points on the same XY plane in a measurement area are grouped, the groups are further layered in the descending order of a value of a Z axis, and layer numbers are assigned to the measurement points of the respective layers. A layer width is a division width of the Z axis. In the present embodiment, the layers are set and acquired for the measurement points, and the flowchart of the measurement illustrated in FIG. 19 is executed. In the third embodiment, the measurement is started at measurement points of the first layer, and the measurement is sequentially performed at the lower layers.

As illustrated in FIG. 19, once the measurement starts, steps S21 to S29 are performed as in the first embodiment. Since steps S21 to S29 are similar to those in the first embodiment, a description thereof is omitted.

Next, in step S60, it is checked whether or not imaging for one layer is completed. In a case where the measurement is not completed (No) and the processing proceeds to step S31, and the same processing as in step S31 of the first embodiment is performed to continue the measurement for the same layer. In a case where the processing is completed (Yes), the processing proceeds to step S61. FIG. 21A illustrates measurement points of an N-th layer and a measurement state. Once the measurement at the measurement points of the layer ends, the processing proceeds to step S61.

Next, in step S61, it is checked whether or not the measurement for all the layers has ended. In a case where the measurement has ended (Yes), and the processing proceeds to measurement completion to end the flow. In a case where the processing has not ended (No), the processing proceeds to step S62, and processing of automatically excluding measurement points in a lower layer is performed.

Next, in step S62, pieces of point cloud data within a measurement range and a focus distance range are acquired from all pieces of three-dimensional data and synthesized. FIG. 21B is a schematic view at the time of the point cloud data acquisition processing, and a boundary box VBox in which all the imaging ranges in the N-th layer are set to the XY plane and the focus distance ±Fh is set to the Z direction is created, and point cloud data existing therein is acquired. As a result, only the point cloud data in the range that can be accurately measured can be acquired.

Next, in step S63, mesh processing is performed on the synthesized three-dimensional point cloud data. FIG. 21C is a schematic view of a meshed model, and side information of a measurement object existing in the boundary box VBox can be acquired from the point cloud data.

Next, in step S64, measurement points where a linear model of a focal length h of the sensor intersects the meshed model are excluded. FIG. 21D illustrates a state in which a linear model of a focal length of the sensor for a measurement point in an N+1-th layer and the meshed model intersect (interfere with) each other. Since the measurement point in this state is inside the measurement target, the measurement point can be excluded among the measurement points. FIG. 21E is a schematic view of the excluded measurement points.

Next, in step S65, interference between the meshed model and the robot is checked, and an interfering measurement point is excluded. As a result, it is possible to prevent the robot from contacting with the measurement target. Once the exclusion processing ends, the processing returns to step S31.

By performing the exclusion processing as described above, it is possible to exclude unnecessary measurement points and measurement points having a possibility of interference, and it is possible to shorten a measurement time and reduce a risk of damage to the robot or a peripheral object.

### Fourth Embodiment

In the second embodiment, the movement-prohibited areas 302 and 303 are set by the movement-prohibited area setting section 405. However, for example, in a case where a model of a peripheral device or a model of a wall or a ceiling of a device has already been set in a virtual space, the model may be set, by the movement-prohibited area setting section 405, as the measurement-prohibited area. A description of matters common to the first to third embodiments will be simplified or omitted.

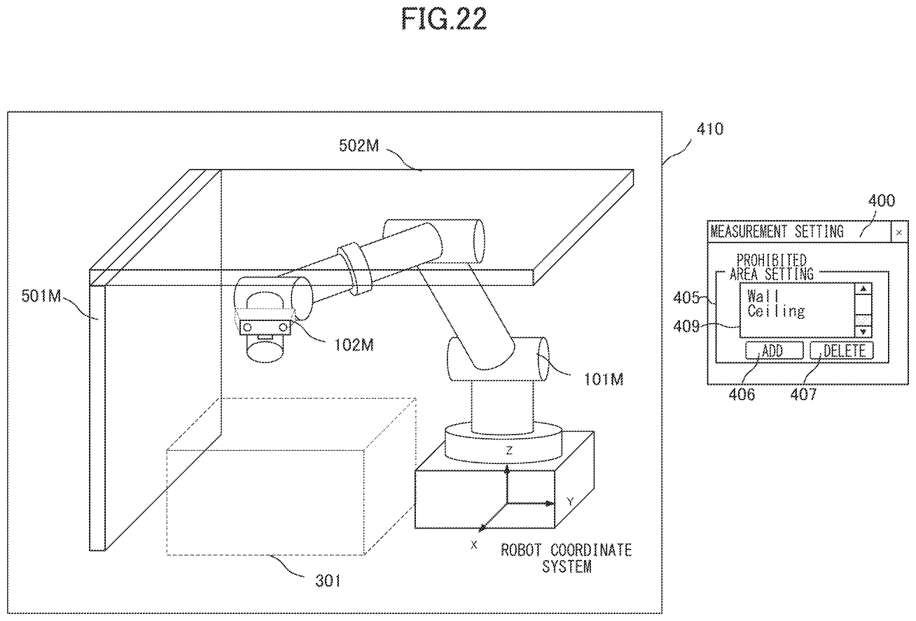

FIG. 22 is an explanatory view of a peripheral model according to a fourth embodiment, and illustrates a state in which a wall model 501M (Wall) and a ceiling model 502M (Ceiling) are displayed on a virtual space screen 410. By selecting the wall model 501M or the ceiling model 502M and pressing an addition button 406 of a movement-prohibited area setting section 405 on a measurement setting screen 400, an existing model can be selected and set as the movement-prohibited area, and step S56 of the second embodiment can be performed.

By performing the above setting, it is possible to prevent interference with a peripheral device, a wall, a ceiling, and the like at a measurement point. In addition, a ceiling, a wall, and the like are rarely moved in a manufacturing line, and update and the like are rarely performed if the ceiling, the wall, and the like are set in advance as a model. Therefore, if a movement-prohibited area can be set by the model as in the present embodiment, it is useful because the user can easily set a movement-prohibited area.

### Fifth Embodiment

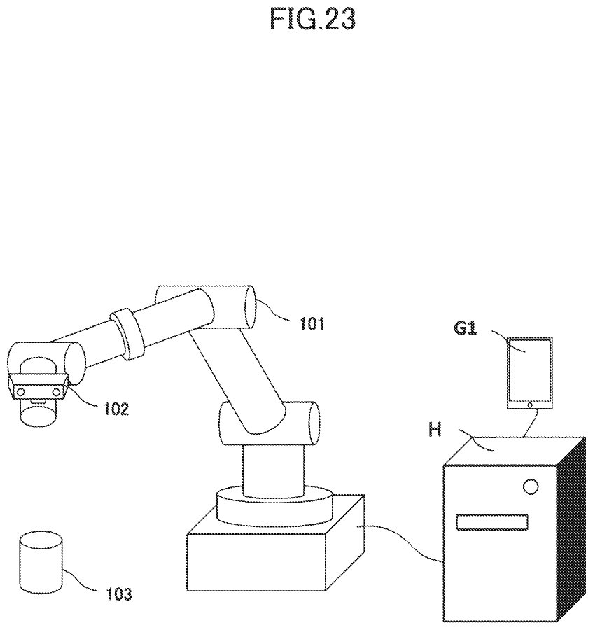

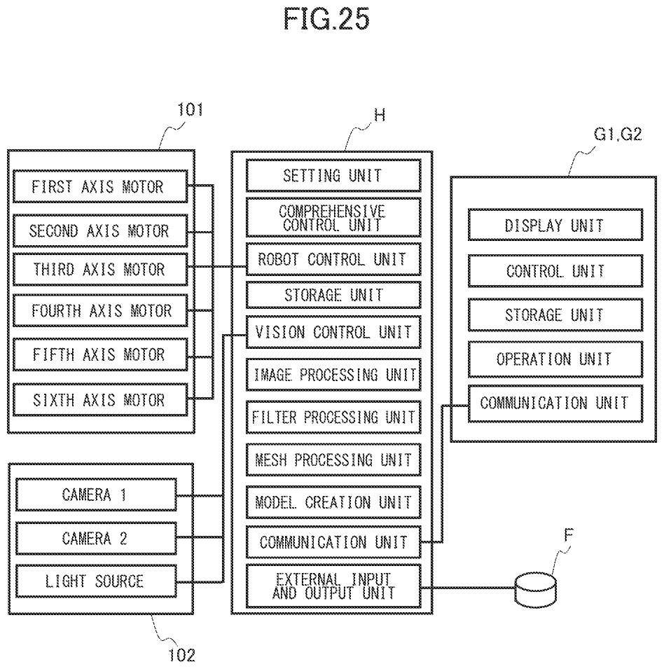

The form of the information processing system that implements the present invention is not limited to the example of the embodiment described with reference to FIGS. 1 and 2. FIG. 23 is a schematic diagram illustrating a schematic configuration of an information processing system according to a fifth embodiment, and FIG. 25 is a functional block diagram for describing the configuration of the information processing system according to the fifth embodiment. A description of matters common to the first to fourth embodiments will be simplified or omitted.

In the fifth embodiment, the robot control device A, the vision sensor control device B, the model creation device C, and the simulation device D described in the first embodiment are integrated as a single information processing device H, and a tablet terminal G1 is communicably connected to the information processing device H. The connection between the information processing device H and the tablet terminal G1 may be wired connection as illustrated in the drawing or wireless connection.

In the present embodiment, measurement preparation (imaging preparation), measurement (imaging), three-dimensional model generation, and simulation in a virtual space are performed in the same procedure as in the first embodiment. At this time, various settings can be input and information can be displayed using the tablet terminal Gl, and thus work efficiency of the operator is improved. The tablet terminal G1 may also have a function as a teaching pendant. The virtual space may be displayed on a display screen of the tablet terminal G1 during offline simulation.

### Sixth Embodiment

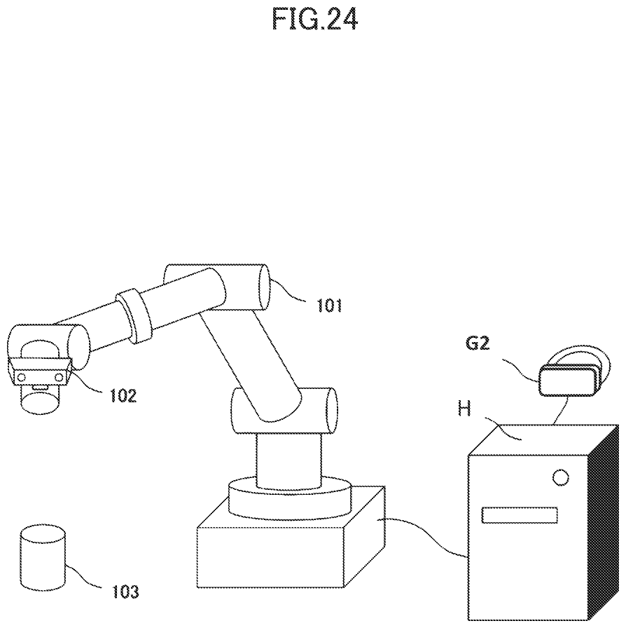

A sixth embodiment is an information processing system in which a head mounted display G2 capable of stereo display is connected to an information processing device H similar to that of the fifth embodiment. FIG. 24 is a schematic diagram illustrating a schematic configuration of the information processing system according to the sixth embodiment, and FIG. 25 is a functional block diagram for describing the configuration of the information processing system according to the sixth embodiment. A description of matters common to the first to fifth embodiments will be simplified or omitted.

In the sixth embodiment, the robot control device A, the vision sensor control device B, the model creation device C, and the simulation device D described in the first embodiment are integrated as a single information processing device H. At the same time, a head mounted display G2 is communicably connected to the information processing device H. The connection between the information processing device H and the head mounted display G2 may be wired connection as illustrated in the drawing or wireless connection.

In the present embodiment, measurement preparation (imaging preparation), measurement (imaging), three-dimensional model generation, and simulation in a virtual space are performed in the same procedure as in the first embodiment. For example, by using the head mounted display G2 capable of stereo display in confirmation of the generated three-dimensional model and simulation in the virtual space, it becomes easy for the operator to spatially grasp and recognize a robot environment, and work efficiency is improved. The head mounted display G2 may be any device capable of stereo display, and various types of devices such as a helmet type and a goggle type can be used. The information processing device H can display a virtual model and a simulation result to the operator in a form such as virtual reality (VR), augmented reality (AR), mixed reality (MR), or cross reality (XR) by using the virtual model of the robot and the surrounding environment of the robot.

### Seventh Embodiment

In a seventh embodiment, another embodiment in a case where a simulation model of a surrounding environment of a robot is acquired will be described. A description of matters common to the first to sixth embodiments will be simplified or omitted.

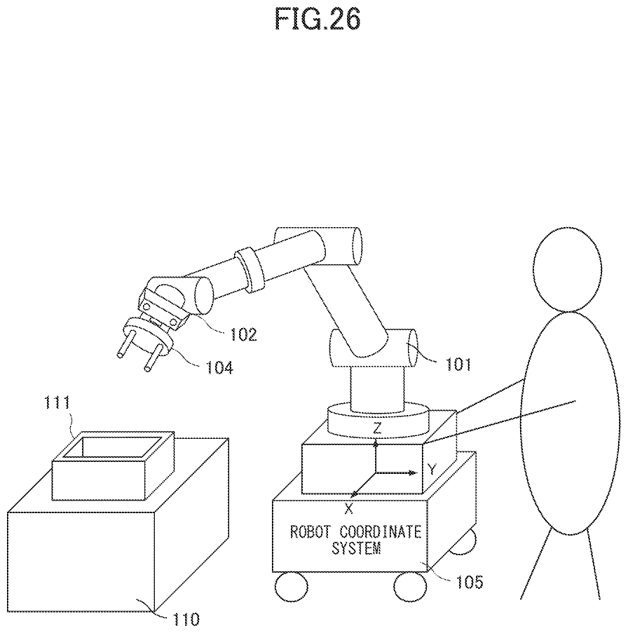

FIG. 26 is a schematic view illustrating a schematic configuration of the robot and a peripheral object according to the seventh embodiment. In the present embodiment, a robot 101 is mounted on a mobile carriage 105, and a person can move the robot 101. A hand 104 is mounted on the robot 101. A box 111 is installed on a pedestal (platform) 110 in front of the mobile carriage 105. This is a situation where the mobile carriage 105 is installed in front of the pedestal 110 and a work of picking a workpiece in the box 111 is performed, and the layout of the robot 101, the pedestal 110, and the box 111 can be arbitrarily changed. In order to pick the workpiece in such a way that the hand 104 does not come into contact with the box 111, it is necessary to adjust a positional relationship between the robot 101 and the box 111.

Therefore, after the mobile carriage 105 is moved, the surrounding environment of the robot is measured by a three-dimensional vision sensor as described in the first embodiment, and the box 111 based on the robot coordinate system is modeled. Furthermore, by setting the created model of the box 111 as a target for which interference with the robot 101 is to be checked, picking can be performed while avoiding the box 111.

As described above, by modeling the real environment in a case where a positional relationship between a target and the robot 101 is unclear, it is possible to smoothly perform the picking work without the need to manually create a CAD model and perform layout. In addition, a positional relationship between the robot and a peripheral object can be grasped by the acquired model based on the robot coordinate system. Therefore, even in a case where a person roughly arranges the robot 101 in front of the pedestal 110, it is possible to cause the robot 101 to smoothly perform work while avoiding interference between the hand 104 and the box 111. The mobile carriage 105 may be an automatic guided vehicle (AGV) which is a carriage (conveying vehicle) capable of autonomously moving.

### Modification of Embodiments

Note that the present invention is not limited to the embodiments described above, and many modifications can be made within the technical idea of the present invention. For example, the above-described different embodiments may be implemented in combination.

A control program for performing processing such as virtual model creation, offline simulation, and operation control of an actual device based on a control program created by offline simulation in the above-described embodiment is also included in the embodiment of the present invention. In addition, a computer-readable recording medium storing the control program is also included in the embodiment of the present invention. As the recording medium, for example, a non-volatile memory such as a flexible disk, an optical disk, a magneto-optical disk, a magnetic tape, or a USB memory, a solid-state drive (SSD), or the like can be used.

The information processing system and the information processing method of the present invention can be applied to software design and program development of various machines and facilities such as an industrial robot, a service robot, and a processing machine operated by numerical control by a computer, in addition to production facilities. For example, based on information of the storage device provided in the control device, it is possible to generate a virtual model of a surrounding environment of a device including a movable unit capable of automatically performing operations of expansion and contraction, bending and stretching vertical movement, horizontal movement, or turning, or a combined operation thereof. Further, the present invention can be applied to a case where an operation simulation of the device is performed in a virtual space.

The present invention can also be implemented by processing in which a program for implementing one or more functions of the embodiments is supplied to a system or a device via a network or a storage medium, and one or more processors in a computer of the system or the device read and execute the program. The present invention can also be implemented by a circuit (for example, an application specific integrated circuit (ASIC)) that implements one or more functions.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-72226, filed Apr. 26, 2022, and Japanese Patent Application No. 2023-39698, filed Mar. 14, 2023, which are hereby incorporated by reference herein in their entirety.

What is claimed is:

1. An information processing system comprising:
a device that includes a movable unit including a measurement unit configured to measure a shape of an object; and
a simulation unit that performs an operation simulation for the device in a virtual space by using a virtual model,
wherein
the movable unit moves the measurement unit to a predetermined measurement point,
the measurement unit measures a target existing in a surrounding environment of the device at the predetermined measurement point,
a model including position information of the target is acquired by using a measurement result and information regarding the predetermined measurement point, and the simulation unit sets a virtual model of the target in the virtual space by using the model.

2. The information processing system according to claim 1, wherein
the information regarding the predetermined measurement point includes information regarding a position and a measurement direction of the measurement unit based on a position of the device.

3. The information processing system according to claim 1, wherein
the predetermined measurement point is registered based on setting information input by an operator.

4. The information processing system according to claim 3, wherein
the setting information is information input by the operator while operating the device in advance.

5. The information processing system according to claim 3, wherein
the setting information includes information regarding a measurement target area including the target.

6. The information processing system according to claim 3, wherein
the setting information includes information of a movement-prohibited area to which the movable unit is prohibited from moving.

7. The information processing system according to claim 6, wherein
the movement-prohibited area is settable by a preset virtual model of a peripheral object existing in the surrounding environment.

8. The information processing system according to claim 3, wherein
the setting information includes information regarding number of times of measurement performed by the measurement unit at the predetermined measurement point.

9. The information processing system according to claim 3, wherein
the setting information and/or the information regarding the predetermined measurement point is displayed on a display unit.

10. The information processing system according to claim 1, wherein
a plurality of times of measurement is performed at the predetermined measurement point, measurement results of the plurality of times of measurement are synthesized to acquire three-dimensional point cloud data including the position information of the target, and the model is acquired based on the three-dimensional point cloud data.

11. The information processing system according to claim 1, wherein
a plurality of measurement points is registered as the predetermined measurement point in such a way that a measurement range of the measurement unit covers the target.

12. The information processing system according to claim 11, wherein
measurement results obtained at the plurality of measurement points are synthesized to acquire three-dimensional point cloud data including the position information of the target.

13. The information processing system according to claim 10, wherein
after synthesizing the measurement results, filter processing is performed on the three-dimensional point cloud data.

14. The information processing system according to claim 1, wherein
the simulation unit is configured to display the virtual model of the target set in the virtual space on a display unit.

15. The information processing system according to claim 1, wherein
a setting screen with which information regarding the measurement unit and information regarding a measurement area related to the measurement are settable by a user is displayed.

16. The information processing system according to claim 15, wherein
the predetermined measurement point is automatically acquired based on the information set using the setting screen.

17. The information processing system according to claim 6, wherein
at least two postures of the measurement unit are set at the predetermined measurement point, and
in a case where the measurement unit interferes with the movement-prohibited area due to movement of the measurement unit to the predetermined measurement point, the predetermined measurement point interfering with the movement-prohibited area is excluded.

18. The information processing system according to claim 1, wherein
the predetermined measurement point that is outside a movable range of the device is excluded.

19. The information processing system according to claim 1, wherein
the predetermined measurement point is divided into at least two layers based on a measurement area related to the measurement, and
the predetermined measurement point interfering with the model is excluded based on the layers.

20. The information processing system according to claim 14, wherein
the simulation unit is configured to display the virtual model of the target set in the virtual space on a tablet terminal or a head mounted display.

21. The information processing system according to claim 14, wherein
the simulation unit is configured to display the virtual model of the target in a form of any one of virtual reality (VR), augmented reality (AR), mixed reality (MR), and cross reality (XR).

22. The information processing system according to claim 1, wherein
the device is mounted on a carriage, and the target is placed on a pedestal.

23. An information processing method comprising:
creating, by using the information processing system according to claim 1, a control program for the device by performing the operation simulation for the device in the virtual space.

24. A non-transitory computer-readable recording medium recording a program for causing a computer to execute the information processing method according to claim 23.

25. A robot system comprising:
a robot that includes a movable unit including a measurement unit configured to measure a shape of an object; and
a simulation unit that performs an operation simulation for the robot in a virtual space by using a virtual model,
wherein
the movable unit moves the measurement unit to a predetermined measurement point,
the measurement unit measures a target existing in a surrounding environment of the robot at the predetermined measurement point,
a model including position information of the target is acquired by using a measurement result and information regarding the predetermined measurement point, and the simulation unit sets a virtual model of the target in the virtual space by using the model.

26. A robot system control method comprising:
creating, by using the robot system according to claim 25, a control program for the robot by performing the operation simulation for the robot in the virtual space.

27. A method for manufacturing an article by using a robot system, the method comprising:
performing, by using the robot system control method according to claim 26, a simulation related to an operation of the robot for manufacturing the article in the virtual space; creating a control program for the robot related to the manufacturing of the article; and operating the robot by using the control program to manufacture the article.
